(19) United States
(12) Patent Application Publication
(10) Pub. No.: US 2010/0073440 A1
(43) Pub. Date: Mar. 25, 2010

(54) LIQUID APPLICATION APPARATUS AND METHOD, AND IMAGE FORMING APPARATUS

(76) Inventor: Koji FURUKAWA, Ashigarakami-gun (JP)

Correspondence Address: BIRCH STEWART KOLASCH & BIRCH, PO BOX 747, FALLS CHURCH, VA, 22040-0747, US

(21) Appl. No.: 12/562,646

(22) Filed: Sep. 18, 2009

(30) Foreign Application Priority Data
Sep. 19, 2008 (JP) 2008-241526

(51) Int. Cl. B41J 2/175

(52) U.S. Cl. 347/85

(57) ABSTRACT

The liquid application apparatus includes: an application member which has an application surface to apply liquid to a medium; a holding member which holds the liquid in a liquid holding space formed by abutting against the application surface of the application member, the liquid supplied to the application surface by the holding member being applied to the medium by rotating the application surface of the application member; a storage device which stores the liquid, the storage device including a liquid cartridge having a filter to trap foreign matter contained in the liquid, the liquid cartridge being detachable with respect to the storage device; first and second flow channels which connect the storage device and the holding member; and a first liquid movement device which generates a flow of the liquid in a course including the first and second flow channels and the liquid holding space.

### BACKGROUND OF THE INVENTION

1. Field of the Invention

The present invention relates to a liquid application apparatus and a liquid application method and an image forming apparatus, and more particularly to liquid application technology that can be used desirably for depositing a treatment liquid on a recording medium prior to the deposition of an ink by means of an inkjet recording apparatus in order to promote aggregation of a color material of the ink, for example.

2. Description of the Related Art

In order to realize a high quality printing by an inkjet recording apparatus, the technology is known in which a treatment liquid, such as multivalent metal salt aqueous solution or acid aqueous solution, is deposited on a recording medium prior to depositing an ink thereon, so that the treatment liquid reacts with the ink on the recording medium so as to prevent the breeding or color mixture of the ink.

Japanese Patent Application Publication No. 2006-167556 discloses a liquid application apparatus that includes: as a mechanism for supplying application liquid such as treatment liquid to an application medium (hereinafter also referred to simply as “medium”), an application roller serving as an application member, which has an application surface for applying the application liquid to the medium; and a liquid holding member, which holds the application liquid in a liquid holding space that is formed by abutting against a circumferential surface (roller surface) of the application roller, wherein the liquid application apparatus is configured to apply the application liquid to the medium by rotating the application roller, and the application liquid is supplied to the circumferential surface of the application roller by the liquid holding member.

In this liquid application apparatus, in cases where the apparatus is left standing for a long time in a halted condition, solvent in the application liquid evaporates in a flow channel for supplying or returning the application liquid between the liquid holding member and a storage device storing the application liquid, thereby generating a thickening or adhesion of the application liquid and impeding the favorable supply and return of the application liquid; furthermore, when thickened material enters the liquid holding space and the thickened material adheres to the application surface of the application member, this results in an uneven application or other adverse effect. In order to solve these problems, an avoidance space is provided in the flow channel for supplying or returning the application liquid, as a product recovery section for recovering thickened material (the application liquid thickens, becoming pasty or gel-like), and fixed material (with a higher viscosity than the thickened material). The avoidance space is a space which is provided in a prescribed position of the flow channel for supplying or returning the application liquid, and composed such that the surface area of a vertical cross-section of the flow channel in which the avoidance space is provided, in the flow direction of the liquid (that is, the application liquid), is formed larger than the cross-sectional area of the remaining parts (supply flow channel and return flow channel).

When the products such as the thickened or fixed materials of the application liquid are mixed together with the application liquid for a long time, the products become dissolved with the application liquid to a certain extent, and blocking of the flow channels can therefore be prevented to a degree. However, when, due to an application operation, foreign matter such as dust mixes with the application liquid, this foreign matter is incompatible with the application liquid and therefore builds up in the avoidance space, risking blockage of the flow channels.

### SUMMARY OF THE INVENTION

The present invention has been contrived in view of the above-described circumstances, and an object of the invention is to provide a liquid application apparatus and method, and an image forming apparatus that prevent a flow channel for supplying or returning application liquid from being blocked and abnormal application, thereby improving application stability.

In order to attain the aforementioned object, the present invention is directed to a liquid application apparatus, comprising: an application member which has an application surface to apply liquid to a medium; a holding member which holds the liquid in a liquid holding space formed by abutting against the application surface of the application member, the liquid supplied to the application surface by the holding member being applied to the medium by rotating the application surface of the application member; a storage device which stores the liquid, the storage device including a liquid cartridge having a filter to trap foreign matter contained in the liquid, the liquid cartridge being detachable with respect to the storage device; first and second flow channels which connect the storage device and the holding member; and a first liquid movement device which generates a flow of the liquid in a course including the first and second flow channels and the liquid holding space.

According to this aspect of the present invention, even when dust or other foreign matter (material which is incompatible with the liquid) mixes with the liquid, the foreign matter can be trapped in the filter of the liquid cartridge included in the storage device, and when the liquid cartridge is replaced, all the foreign matter trapped by the filter can be easily removed at the same time. Consequently, blockage of the flow channels and abnormal application can be prevented, thereby improving application stability.

Preferably, the liquid cartridge is detachably arranged midway in the course including the first and second flow channels and the liquid holding space.

According to this aspect of the present invention, when the liquid is caused to circulate through the course including the first and second flow channels and the liquid holding space, foreign matter contained in the liquid can be trapped by the liquid cartridge filter, efficiently preventing flow channel blockage and abnormal application.

Preferably, a member contacting the liquid in each of the first and second flow channels has gas barrier properties.

Preferably, the storage device includes a liquid storage tank which stores the liquid; the liquid storage tank is fixedly arranged midway in the course including the first and second flow channels and the liquid holding space, and has a circulation channel different from the course; the circulation channel has a second liquid movement device which generates a flow of the liquid in the circulation channel; and the liquid cartridge is detachably arranged midway in the circulation channel.

According to this aspect of the present invention, when the liquid in the liquid storage device is caused to circulate through the circulation channel, foreign matter contained in the liquid can be trapped by the liquid cartridge filter, efficiently preventing channel blockage and abnormal application.

Preferably, a member contacting the liquid in each of the first and second channels and the circulation channel has gas barrier properties.

In order to attain the aforementioned object, the present invention is also directed to an image forming apparatus, comprising: a liquid application apparatus which includes: an application member which has an application surface to apply a first liquid to a recording medium; a holding member which holds the first liquid in a liquid holding space formed by abutting against the application surface of the application member, the first liquid supplied to the application surface by the holding member being applied to the recording medium by rotating the application surface of the application member; a storage device which stores the first liquid, the storage device including a liquid cartridge having a filter to trap foreign matter contained in the first liquid, the liquid cartridge being detachable with respect to the storage device; first and second flow channels which connect the storage device and the holding member; and a first liquid movement device which generates a flow of the first liquid in a course including the first and second flow channels and the liquid holding space; and a recording device which ejects and deposits a second liquid from a recording head to record an image onto the recording medium having been applied with the first liquid by the liquid application apparatus.

According to this aspect of the present invention, the accuracy of the amount of the treatment liquid applied to the recording medium can be improved, preventing image degradation caused by uneven application, and enabling the formation of a high-quality image.

In order to attain the aforementioned object, the present invention is also directed to a liquid application method using a liquid application apparatus which comprises: an application member which has an application surface to apply liquid to a medium; a holding member which holds the liquid in a liquid holding space formed by abutting against the application surface of the application member, the liquid supplied to the application surface by the holding member being applied to the medium by rotating the application surface of the application member; a storage device which stores the liquid, the storage device including a liquid cartridge having a filter to trap foreign matter contained in the liquid, the liquid cartridge being detachable with respect to the storage device; first and second flow channels which connect the storage device and the holding member; and a first liquid movement device which generates a flow of the liquid in a course including the first and second flow channels and the liquid holding space, the method comprising the step of: trapping foreign matter in the liquid using the filter of the liquid cartridge.

Preferably, the liquid application method further comprises the step of replacing the liquid cartridge having trapped the foreign matter with a new liquid cartridge.

According to the present invention, even when dust or other foreign matter (material which is incompatible with the liquid) mixes with the liquid, the foreign matter can be trapped by the liquid cartridge filter in the storage device, and when the liquid cartridge is replaced, all the foreign matter trapped by the filter can be easily removed at the same time. It is thus possible to prevent blockage of the channels and abnormal application, thereby improving application stability.

### BRIEF DESCRIPTION OF THE DRAWINGS

FIG. 1 shows the overall composition of an inkjet recording apparatus according to an embodiment of the present invention;

FIG. 2 is a cross-sectional view of the composition of a treatment liquid application unit;

FIG. 3 is a plan view of the composition of a liquid holding member;

FIG. 4 is a schematic drawing showing the composition of a liquid supply apparatus;

FIG. 5 is a block diagram showing the composition of a control system for the inkjet recording apparatus;

FIG. 6 is a flowchart of an operational sequence of the inkjet recording apparatus;

FIG. 7 is an illustrative view of an aspect of a treatment liquid application operation; and

FIG. 8 is a schematic drawing showing the composition of an ink supply apparatus according to a second embodiment of the present invention.

### DETAILED DESCRIPTION OF THE PREFERRED EMBODIMENTS

### First Embodiment

Firstly, an inkjet recording apparatus which is one embodiment of an image forming apparatus according to the present invention will be described.

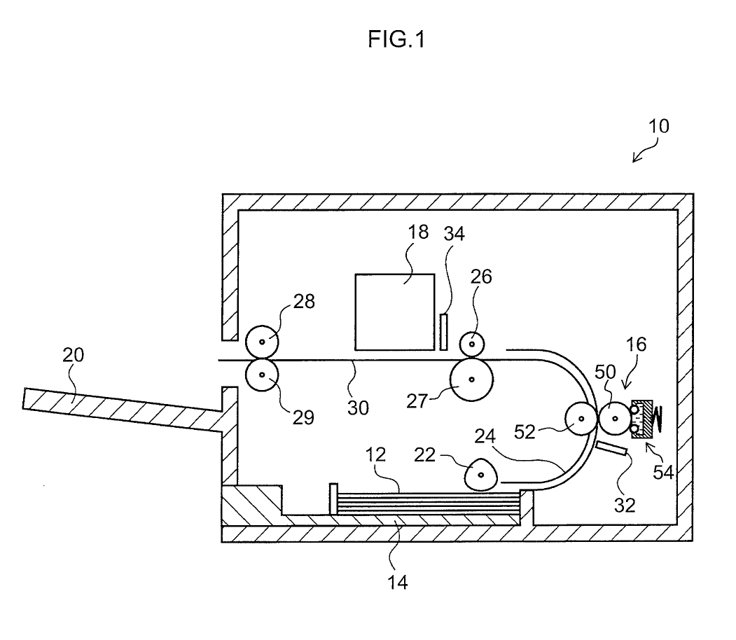

FIG. 1 is a schematic drawing illustrating an overview of an inkjet recording apparatus according to the present embodiment. As illustrated in FIG. 1, the inkjet recording apparatus 10 includes: a paper supply unit 14, which supplies a recording medium 12; a treatment liquid application unit 16, which applies treatment liquid to the recording medium 12 supplied from the paper supply unit 14; an ink droplet ejection unit 18, which ejects droplets of ink onto the recording medium 12 after the deposition of the treatment liquid; and an output tray 20, which outputs the recording medium 12 onto which an image has been formed by the ink droplet ejection unit 18.

The paper supply unit 14 employs a method based on a paper supply cassette in which a plurality of sheets of recording media 12 cut to a prescribed size are loaded. It is also possible to provide a plurality of paper supply cassettes in such a manner that papers of a plurality of different sizes can be supplied. Furthermore, it is also possible to adopt a mode in which rolled paper (continuous paper) is used instead of cut sheet, and the rolled paper is cut to an appropriate size by a cutter.

The treatment liquid application unit 16 has a treatment liquid application device, which applies the treatment liquid to the recording medium 12, and a treatment liquid supply device, which supplies the treatment liquid to the treatment liquid application device.

The treatment liquid application device is constituted of a cylindrical application roller 50 forming an application member, a cylindrical counter roller (medium supporting member) 52, which is disposed so as to oppose the application roller 50, and a roller drive mechanism (not illustrated), which drives the application roller 50, and the like. The application roller 50 and the counter roller 52 are respectively supported rotatably by mutually parallel axes of which the respective ends are installed rotatably on a frame (not illustrated).

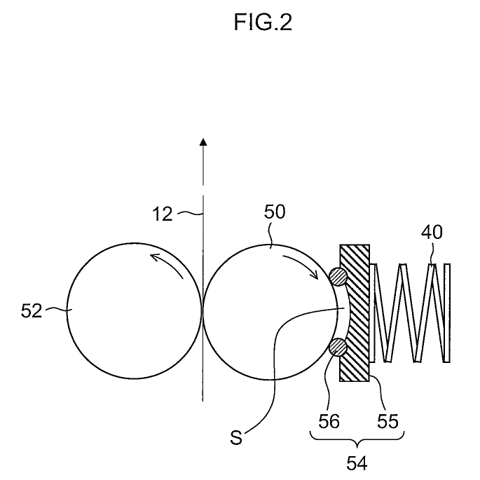

The counter roller 52 is pressed toward the circumferential surface of the application roller 50 by an pressing device (not illustrated), and by rotating the application roller 50 in the clockwise direction in FIGS. 1 and 2, the recording medium 12 is conveyed in the direction of the arrow in FIG. 2 while the recording medium 12 to which the treatment liquid is to be applied is gripped between the two rollers.

The treatment liquid supply device includes: a liquid holding member 54, which holds the treatment liquid between the liquid holding member 54 and the circumferential surface of the application roller 50; and a liquid supply device (not illustrated), which supplies the treatment liquid to the liquid holding member 54. The liquid holding member 54 extends through the lengthwise direction of the application roller 50 and is installed movably on the aforementioned frame through a mechanism which enables separation from the circumferential surface of the application roller 50.

The ink droplet ejection unit 18 is provided on the downstream side of the treatment liquid application unit 16 in terms of the direction of conveyance of the recording medium 12. The ink droplet ejection unit 18 in the present embodiment is constituted of recording heads of an inkjet type which correspond respectively to inks of four colors of yellow (Y), magenta (M), cyan (C) and black (K). Although not illustrated in the drawings, the inks of the corresponding colors are supplied respectively to the recording heads of the respective colors, from ink tanks (not illustrated).

Each of the recording heads of the respective colors in the ink droplet ejection unit 18 is a head of a full line type which has a length corresponding to the maximum width of the image forming region on the recording medium 12 and includes a plurality of ink ejection nozzles arranged through the full width of the image forming region on the ink ejection surface of the head.

Each of the recording heads of the respective colors is fixed so as to extend in a direction perpendicular to the direction of conveyance of the recording medium 12 (the direction perpendicular to the plane of the drawing in FIG. 1), and ejects liquid droplets of the corresponding colored ink onto the recording medium 12 on a platen 30.

In this way, according to a composition in which the full line heads having the nozzle rows covering the full width of the image forming region of the recording medium 12 are provided for each color of ink, it is possible to record an image on the image forming region of the recording medium 12 by performing just one operation of moving the recording medium 12 and the recording heads relatively with respect to each other in the direction of conveyance of the recording medium 12 (the sub-scanning direction), in other words, by performing just one sub-scanning.

It is also possible to adopt a mode which employs, instead of full line heads, heads of a serial (shuttle) type which move reciprocally back and forth in a direction (main scanning direction) perpendicular to the direction of conveyance of the recording medium 12 (sub-scanning direction). Forming an image by the single pass method using the heads of the full line type (page-wide heads) enables faster printing and therefore improves the print productivity than the multi-pass method using the serial (shuttle) type heads.

Although the configuration with the CMYK four colors is described in the present embodiment, combinations of the ink colors and the number of colors are not limited to those. Light inks, dark inks or special color inks can be added as required. For example, a configuration is possible in which recording heads for ejecting light-colored inks such as light cyan and light magenta are added. Furthermore, there are no particular restrictions of the sequence in which the heads of respective colors are arranged.

Possible examples of the ink used in the inkjet recording apparatus 10 in the present embodiment include a dye-based ink in which a coloring material is dissolved in a molecular state (an ionic state is also possible) in the solvent of the liquid, and a pigment-based ink in which a coloring material is dispersed in the solvent of the liquid in a state of small particles.

On the other hand, the treatment liquid is a liquid which generates an aggregate of the coloring material when mixed with the ink. Specific examples of the treatment liquid include a treatment liquid which precipitates or insolubilizes the coloring material in the ink by reacting with the ink, and a treatment liquid which generates a semi-solid material (gel) that includes the coloring material in the ink, and the like.

The means of generating a reaction between the ink and the treatment liquid may be a method which causes an anionic coloring material in the ink to react with a cationic compound in the treatment liquid, a method which aggregates pigment by breaking down the dispersion of the pigment in the ink due to altering the pH of the ink by mixing the ink and the treatment liquid which have different pH values, a method which aggregates the pigment in the ink by breaking down the dispersion of the pigment in the ink due to a reaction with a polyvalent metal salt in the treatment liquid, or the like.

For instance, examples of the treatment liquid having the action of aggregating the coloring material contained in the ink which is ejected as droplets from the ink droplet ejection unit 18 in the present embodiment contain aggregating treatment agents, such as a polyvalent metal salt, polyallylamine, a polyallylamine derivative, an acidic liquid, a cationic surfactant, and the like. By promoting the aggregation of the coloring material on the recording medium 12 by means of the treatment liquid of this kind, it is possible to improve the recording density as well as reducing or preventing bleeding.

According to this composition, the recording media 12 which are loaded in the paper supply unit 14 are supplied to a conveyance path 24, one sheet at a time, by the paper supply roller 22. When the recording medium 12 which has been supplied to the conveyance path 24 from the paper supply unit 14 is fed between the rollers 50 and 52, then the treatment liquid is applied to the recording surface of the recording medium 12 while the application roller 50 is rotated in the clockwise direction in FIG. 1 by the roller drive mechanism and thereby conveys the recording medium 12.

The recording medium 12 onto which the treatment liquid has been applied is conveyed onto the platen 30 by a pair of conveyance rollers 26 and 27, and is moved to a position opposing the ink droplet ejection unit 18, and then ink droplets are ejected and deposited onto the recording surface of the recording medium 12 from the nozzles of the recording heads.

The recording medium 12 on which an image has been formed in this way is output to the output tray 20 by a pair of output rollers 28 and 29.

Medium leading edge detection sensors 32 and 34 which detect the leading edge of the recording medium 12 are disposed in the conveyance path 24 for the recording medium 12. The first medium leading edge detection sensor 32 is disposed in the vicinity of the input to the application roller 50 on the paper supply side. The second medium leading edge detection sensor 34 is disposed in the vicinity of the input to the ink droplet ejection unit 18 on the paper supply side.

The treatment liquid application timing and the ink droplet ejection timing are controlled by determining the position of the recording medium 12 by means of these sensors 32 and 34.

Next, the composition of the treatment liquid application unit 16 will be described in detail.

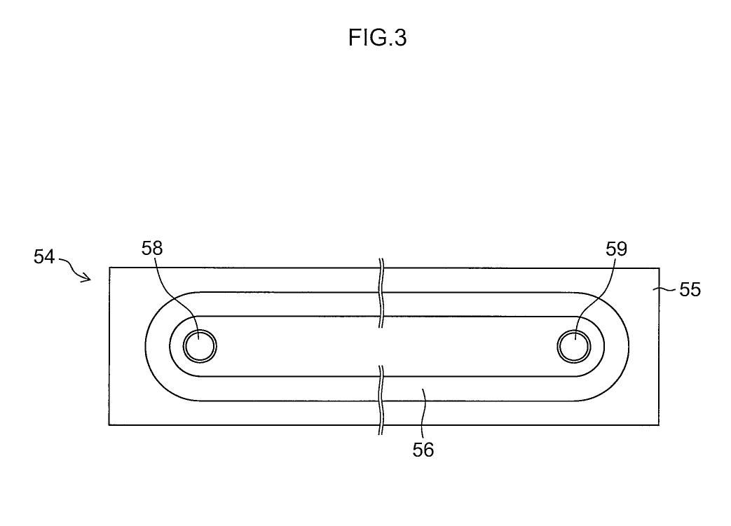

FIG. 2 is a cross-sectional diagram showing the composition of the treatment liquid application unit 16. FIG. 3 is a plan diagram showing the composition of the liquid holding member 54. As shown in FIGS. 2 and 3, the liquid holding member 54, which forms a part of the treatment liquid application unit 16, has a space forming base member 55, and an annular abutting member 56 arranged protrudingly on a face of the space forming base member 55. A spring member 40 (see FIG. 1) is arranged on the rear side of the liquid holding member 54 such that the liquid holding member 54 is pressed by the pressing force of the spring member 40 against the circumferential surface of the application roller 50. By this means, in a state where the abutting member 56 of the liquid holding member 54 is abutted (in tight contact) so as to press against the circumferential surface of the application roller 50, a liquid holding space S is formed which is sealed off (hermetically closed) by the abutting member 56, the face of the space forming base member 55, and the circumferential surface of the application roller 50.

Further, a liquid supply port 58 and a liquid return port 59 formed so as to pass through the space forming base member 55 are arranged in the region of the liquid holding member 54 that is surrounded by the abutting member 56 (see FIG. 3).

Furthermore, during a printing operation (in other words, during an application operation), the treatment liquid is caused to circulate within the liquid holding space S by allowing the treatment liquid to flow out through the liquid return port 59 while supplying the treatment liquid to the liquid holding space S through the liquid supply port 58.

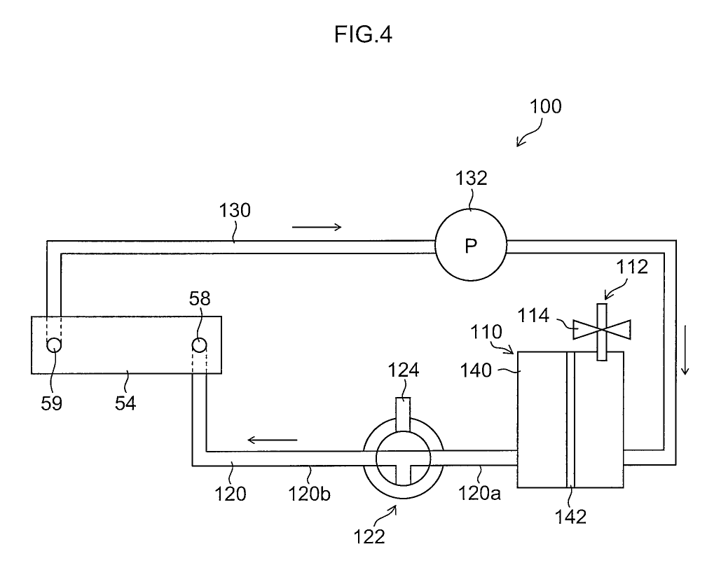

FIG. 4 is a schematic drawing showing the composition of an embodiment of the liquid supply apparatus connected to the liquid holding member 54. As shown in FIG. 4, the liquid supply apparatus 100 includes: a liquid storage device 110, which stores the treatment liquid; a supply flow channel 120 for supplying the treatment liquid to the liquid supply port 58 of the liquid holding member 54 from the liquid storage device 110; and a return flow channel 130 for returning the treatment liquid to the storage device 110 from the liquid return port 59 of the liquid holding member 54.

The liquid storage device 110 in the present embodiment has a liquid cartridge 140 with a built-in filter 142 for trapping foreign matter and so on. The liquid cartridge 140 is configured to be detachable from the liquid supply apparatus 100 such that a used cartridge can be replaced with a new cartridge, and the foreign matter having been trapped by the filter 142 can be removed together.

An air connection pipe (air connection port) 112, which connects the liquid storage unit (that is, the interior of the liquid cartridge 140) of liquid storage device 110 with the air, is provided and has an air connection valve 114 for switching between an air connection and air shutoff. The air connection pipe 112 is configured to be detachable from the liquid cartridge 140, and the air connection pipe 112 is connected to the liquid cartridge 140 in a state where the liquid cartridge 140 is mounted in the liquid supply apparatus 100.

The first end of the supply flow channel 120 is connected to the liquid cartridge 140 constituting the liquid storage device 110, while the second end of the supply flow channel 120 is connected to the liquid supply port 58 of the liquid holding member 54. The first end of the supply flow channel 120 is connected downstream of the filter 142 of the liquid cartridge 140 in the liquid circulation direction (region to the left-hand side of the filter 142 in FIG. 4).

Furthermore, the opening in the side of the liquid cartridge 140 of the supply flow channel 120 is disposed at the bottom of the liquid cartridge 140 (or in a position close to the bottom) so that the treatment liquid in the liquid cartridge 140 can be completely consumed.

A three way valve 122 is arranged in the supply flow channel 120. The three way valve 122 has three ports mutually connected, and two of these ports can be connected selectively to any two of the liquid storage device side flow channel 120a and the liquid holding member side flow channel 120b in the supply flow channel 120, and the air connection port 124. By switching the three way valve 122, it is possible to switch selectively between a state where the liquid storage device side flow channel 120a and the liquid holding member side flow channel 120b are connected (hereinafter referred to as a “connected state”) and a state where the liquid holding member side flow channel 120b and the air connection port 124 are connected (hereinafter referred to as an “air connected state”), and thereby it is possible to supply either the treatment liquid inside the liquid cartridge 140 or air taken in through the air connection port 124, to the liquid holding space S formed by the liquid holding member 54 and the application roller 50.

The first end of the return flow channel 130 is connected to the liquid cartridge 140, while the second end of the return flow channel 130 is connected to the liquid return port 59 of the liquid holding member 54. The first end of the return flow channel 130 is connected upstream of the filter 142 of the liquid cartridge 140 in the liquid circulation direction (region to the right-hand side of the filter 142 in FIG. 4).

The return flow channel 130 is provided with a pump 132 for generating a forced flow of the liquid or air in the direction of the arrows in FIG. 4.

Examples of substances that may be used for the tubes constituting the supply flow channel 120 and the return flow channel 130 include polypropylene, polyethylenechlorofluoroethylene, polyethylene tetrafluoroethylene, ethylene vinyl acetate resin, polyethylene vinyl alcohol, polytetrafluoroethylene hexafluoropropylene, polystyrene, polyethylene, nylon, polyethylene terephthalate, polyamide, polyamide-imide, polyarylate, polycarbonate, poly-3-fluoroethylene, poly(ether ether ketone), polyethylene naphthalate, polyetherimide, polyethersulfone, polyimide, tetrafluoroethylene-perfluoroalkylvinylether, polyparabanic acid, polyphenylene sulfide, polysulfone, poly-4-fluoroethylene, polyvinyl acetate, polyvinyl chloride, polyfluorovinyl, polyvinylidene chloride (PVDC), polyfluorovinylidene, polybutyrene terephthalate, iomer resin, polyacrylonitrile (PAN), polyester, polymethylmethacrylate, polyurethane, polybutadiene, poly-4-methylpentane, cellulose acetate resin, ethyl cellulose resin, polyvinyl alcohol, polylactic acid, and ABS.

Among the aforementioned substances, polyvinylidene chloride (PVDC), ethylene vinylalcohol copolymer (EVOH), and polyacrylonitrile (PAN) are preferably used in liquid-wetted locations due to their gas barrier properties.

Moreover, a metal tube, or a material on which a metal is vapor-deposited, or a film of thin, planar-oriented mica is also effective.

With this composition, when the application liquid (the treatment liquid in the present embodiment) is circulating through a course (also referred to as a “first circuit”) constituted of the supply flow channel 120, the liquid holding space S, and the return flow channel 130 in response to driving of the pump 132, the filter 142 of the liquid cartridge 140 can trap not only products such as thickened material of the application liquid generated by evaporation of the solvent and so on (the application liquid thickens, becoming pasty or gel-like), and fixed material (with a higher viscosity than the thickened material), but also dust or other foreign matter (incompatible with the application liquid) that mixes with the application liquid as a result of an application operation or the like.

Furthermore, the liquid cartridge 140 is configured to be replaceable (detachable) and, in cases where there is a build-up of foreign matter or the like trapped by the filter 142, all the foreign matter can be removed by replacing the cartridge as a whole with a new cartridge.

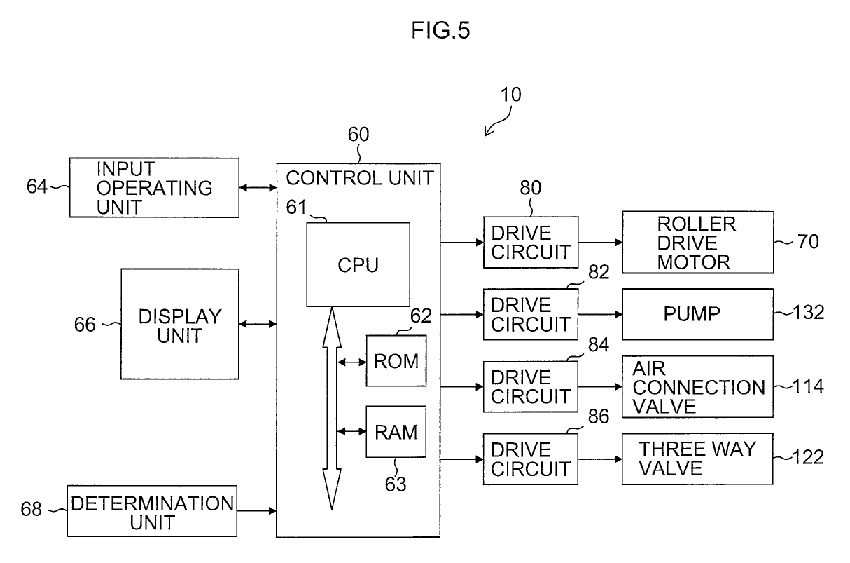

FIG. 5 is a block diagram illustrating the composition of the control system of the inkjet recording apparatus 10 in the present embodiment.

In FIG. 5, a control unit 60 (which is equivalent to a “drive control device”) is a control device which performs overall control of the whole of the inkjet recording apparatus 10. The control unit 60 includes: a CPU (Central Processing Unit) 61, which executes processing of various types in accordance with prescribed programs; a ROM (Read Only Memory) 62, which stores programs, data of various types, and the like; and a RAM (Random Access Memory) 63, which temporarily stores data, and the like, that are used in the various types of processing.

An input operating unit 64 is constituted of, for example, a keyboard or mouse (or various switches, and the like) which is used to enter prescribed instructions or data. A display unit 66 constitutes a user interface together with the input operating unit 64 and provides various displays in conjunction with the control unit 60. For example, the display unit 66 is constituted of a liquid crystal display.

The inkjet recording apparatus 10 includes a detection unit 68, which includes a sensor (medium size determination sensor) for determining the width of the recording medium 12 (see FIG. 1) (the size in the breadthways direction perpendicular to the medium conveyance direction), a sensor (medium position determination sensor) for determining the position of the medium, and in addition to these, sensors which determine the operational states of the respective units, and the like. The signals from the detection unit 68 are sent to the control unit 60, and are used to control operations such as the drive of the rollers, and the like. The detection unit 68 includes the medium leading edge detection sensors 32 and 34 shown in FIG. 1.

The inkjet recording apparatus 10 further includes: a roller drive motor 70, which drives the application roller 50 (see FIG. 1); the pump 132 (see FIG. 5); the air connection valve 114; the three way valve 122; and drive circuits 80, 82, 84 and 86 corresponding to these respective elements. The control unit 60 sends control signals to the respective drive circuits 80 to 88 in accordance with programs, and thereby controls the operation of the respective elements.

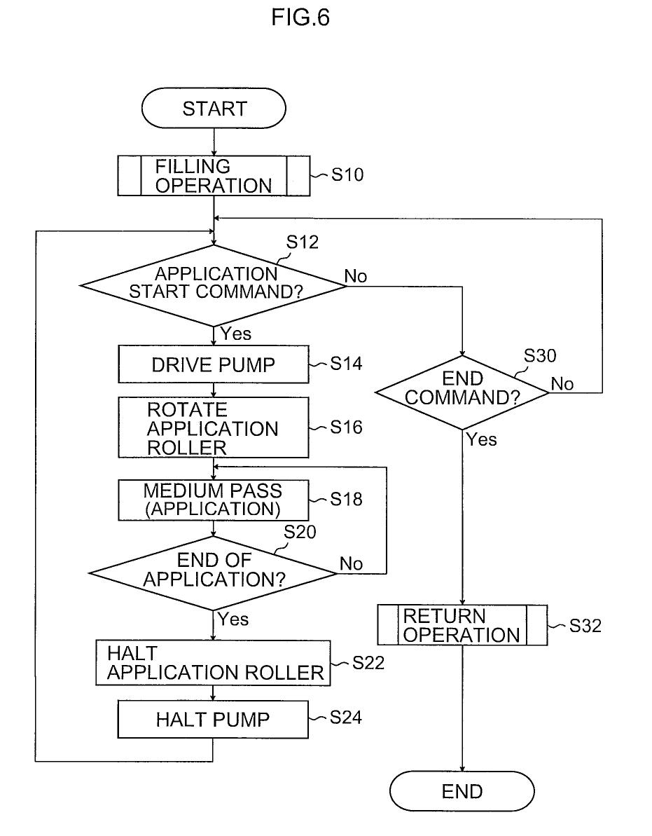

FIG. 6 is a flowchart showing the operational sequence of the inkjet recording apparatus 10. These operations are executed in accordance with a program under the control of the control unit 60 shown in FIG. 5. In the initial state at the start of this sequence, it is supposed that the course including the liquid holding space S and the flow channels 120 and 130 is not filled with the treatment liquid.

Firstly, when the power supply of the apparatus is turned on, the filling operation (supply operation) for filling the treatment liquid into the liquid holding space S is carried out (step S10).

In the filling operation, the air connection valve 114 of the liquid storage device 110 is opened, the three way valve 122 is switched so as to set the supply flow channel 120 to the connected state (the state where the liquid storage device side flow channel 120a and the liquid holding member side flow channel 120b are connected), and the pump 132 is driven for a fixed duration. The duration for driving the pump 132 is set by estimating the time taken to fill the parts with the treatment liquid (in other words, the time taken to discharge all the air that is present in the parts).

The air present in the course including the liquid holding space S and the channels 120 and 130 is thus fed to the liquid cartridge 140 constituting the liquid storage device 110, and the entire course is filled with the treatment liquid so that a state is assumed where the treatment liquid can be supplied to the application roller 50 contacting the liquid holding space S.

After the filling operation has been carried out in this way, the presence or absence of an application start command is judged (step S12). An application start command signal is issued in coordination with the conveyance of the recording medium 12. The application start command signal is issued at a prescribed time differential in such a manner that the application of the treatment liquid starts at the timing that the recording medium 12 arrives at the nip section between the application roller 50 and the counter roller 52.

When the application start command is input and a Yes verdict is obtained at step S12, then the pump 132 is driven (step S14), and furthermore the roller driving is started to rotate the application roller 50 in the clockwise direction in FIG. 1 (step S16).

Thereby, the treatment liquid held in the liquid holding space S adheres and forms a layer of the treatment liquid onto the outer circumferential surface of the application roller 50 while withstanding the pressing force of the abutting member 56 of the liquid holding member 54 against the application roller 50. The treatment liquid that has adhered to the outer circumferential surface of the application roller 50 is supplied to the section abutting with the counter roller 52 due to the rotation of the application roller 50.

Thereupon, the recording medium 12 is conveyed between the application roller 50 and the counter roller 52 by the medium conveyance mechanism, the recording medium 12 is introduced between the rollers 50 and 52, and then the recording medium 12 is conveyed toward the paper output unit due to the rotation of the application roller 50 and the counter roller 52. The treatment liquid that has been applied to the outer circumferential surface of the application roller 50 is transferred to the recording medium 12 during this conveyance process (step S18).

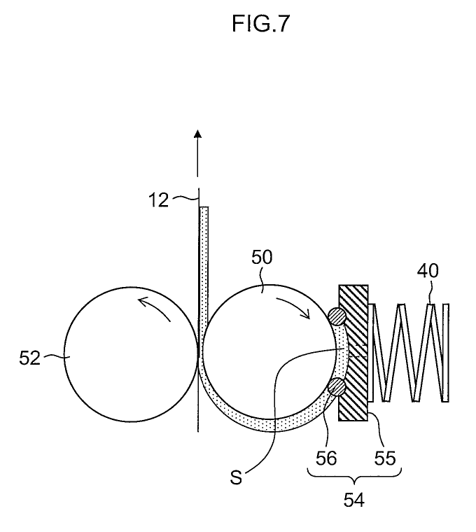

FIG. 7 shows an aspect of the application operation in step S18. The thickness of the treatment liquid layer in FIG. 7 is exaggeratingly depicted to be much larger than its actual size ratio. As shown in FIG. 7, the recording medium 12 which is sandwiched between the application roller 50 and the counter roller 52 is conveyed in the direction of the arrow in FIG. 7 due to the rotational force of the application roller 50, and furthermore the treatment liquid supplied to the outer circumferential surface of the application roller 50 is applied to the recording medium 12. Thus, the treatment liquid of a uniform volume is deposited onto the recording surface of the recording medium 12 which has passed between the application roller 50 and the counter roller 52.

In order to improve the transfer characteristics of the treatment liquid from the application roller 50 to the recording medium 12, it is desirable that the surface free energy of the application roller 50 should be lower than the surface free energy of the recording medium 12. In other words, a material that satisfies the following inequality is employed as the surface member of the application roller 50:

“Surface free energy of application roller”<“Surface free energy of recording medium”.

When the application operation onto the recording medium 12 described above has been carried out, the control unit 60 judges the end timing of the application operation (step S20). If the treatment liquid is applied to the whole surface of the recording medium 12, then the judgment at step S20 produces a No verdict and returns to step S18 until the recording medium 12 has passed completely.

If it is judged that the application operation to the required application range has been completed (Yes verdict at step S20), for instance, the timing of the passage of the trailing edge of the recording medium 12 is detected or the end of a job of a specified number of sheets is detected, then the application roller 50 is halted (step S22), the pump 132 is halted (step S24), and the procedure returns to step S14.

The surface of the counter roller 52 has high liquid-repelling properties, due to a fluoride coating or the like, and is composed in such a manner that the treatment liquid does not become attached readily to the surface of the counter roller 52 due to contact between the application roller 50 and the counter roller 52. By suitably designing the relationship between the free surface energies of the surface members of the respective rollers, it is possible to prevent the treatment liquid from becoming attached to the counter roller 52. Furthermore, a desirable mode is one in which a movement mechanism that alters the relative distance between the application roller 50 and the counter roller 52 is provided in at least one of the rollers, and if it is judged that the application operation has been completed at step S20, then the adherence of the treatment liquid to the surface of the counter roller 52 is prevented by setting the rollers to a mutually separated state.

At step S12, if a new application start command is entered, then the procedure in step S14 to step S24 described above is repeated. On the other hand, if an application start command has not been input at step S12, then the procedure advances to step S30, and it is judged whether or not there is an application end command (step S30). The end command may use one of various modes, such as a mode where an end command is automatically issued when a specified wait time has elapsed on the basis of time management using a timer, or the like, a mode where an end command is issued when the application onto a specified number of sheets of media has been completed, a mode based on an operation through the input operating unit 64, or a mode based on a switching off operation of the apparatus power supply, or the like.

If an end command has not been input at step S30, then the procedure returns to step S12. If an end command has been input at step S30, then the return operation of returning the treatment liquid inside the liquid holding space S is carried out (step S32).

In the return operation, the air connection valve 114 of the liquid storage device 110 is opened, the three way valve 122 is switched so as to set the supply flow channel 120 to the air-connected state (the state where the liquid holding member side flow channel 120b and the air connection port 124 are connected), and the pump 132 is driven for a fixed duration. The duration for driving the pump 132 is set by estimating the time taken to return all the treatment liquid in the parts (in other words, the time taken to fill the parts with air).

Thus, the treatment liquid, which has been present in the course that includes the liquid holding space S and extends from the liquid holding member side flow channel 120b of the supply flow channel 120, to the return flow channel 130, is fed to the liquid cartridge 140 constituting the liquid storage device 110, whereby a state is assumed in which the air taken in through the air connection port 124 fills the entire course.

After the return operation, the air connection valve 114 is closed, the three way valve 122 is switched so as to disconnect the liquid holding member side flow channel 120b from the air connection port 124, and the liquid cartridge 140 is shut off from the air, thereby preventing evaporation and outflow of the liquid.

In the operation sequence described above, when the application liquid (the treatment liquid in the present embodiment) is circulating through the course constituted of the supply flow channel 120, the liquid holding space S and the return flow channel 130, this leads not only to the generation of products such as thickened material of the application liquid caused by evaporation of the solvent (the application liquid thickens, becoming pasty or gel-like), and fixed material (with a higher viscosity than the thickened material), but also to mixing of dust or other foreign matter (incompatible with the application liquid) with the application liquid as a result of the application operation or the like, which causes channel blockage and abnormal application and so on.

According to the present embodiment, as described above, the liquid storage device 110 includes the liquid cartridge 140, which has the built-in filter 142 and is configured to be detachable (replaceable), so that foreign matter (dust and so on) and products (thickened and fixed material) of the application liquid can be trapped by the filter 142 when the application liquid is circulating through the circuit, and all the foreign matter and so on trapped by the filter 142 can be easily removed along with the liquid cartridge 140 when the liquid cartridge 140 is replaced with a new cartridge. Hence, even when foreign matter mixes with the application liquid, this foreign matter can be reliably removed, thereby preventing channel blockage and abnormal application, and improving application stability.

### Second Embodiment

A second embodiment of the present invention is described below. Description on the parts common to the first embodiment is omitted, and the focus of the description is on parts that characterize the present embodiment.

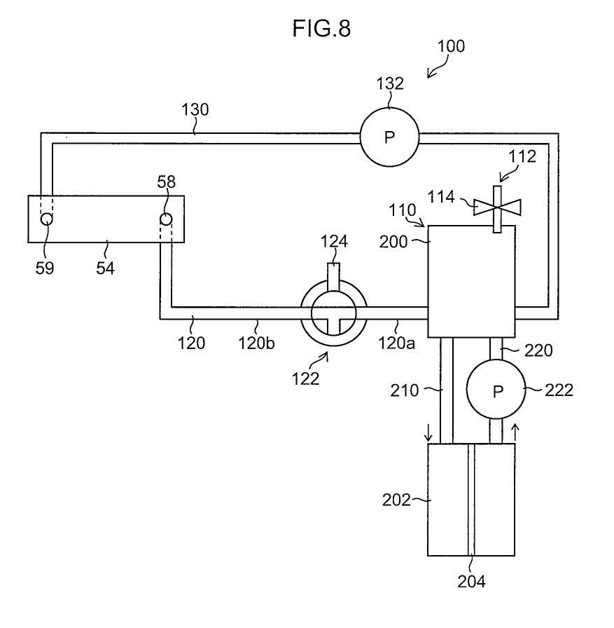

FIG. 8 is a schematic drawing showing the composition of a liquid supply apparatus according to the second embodiment. The parts shown in FIG. 8 common to FIG. 4 have been denoted with the same reference numerals.

The liquid storage device 110 according to the second embodiment includes a liquid storage tank 200 and a liquid cartridge 202, as shown in FIG. 8.

More specifically, the liquid storage tank 200 is arranged in place of the liquid cartridge 140 shown in FIG. 4, and the liquid cartridge 202 having a built-in filter 204 is connected to the liquid storage tank 200 through circulation channels 210 and 220. The liquid cartridge 202 is configured to be detachable (replaceable) in the same way as the liquid cartridge 140 shown in FIG. 4.

The air connection pipe 112 has the air connection valve 114 for switching between air connection and shutoff, and is connected to the liquid storage tank 200. One ends of the supply flow channel 120 and the return flow channel 130 are connected to the liquid storage tank 200.

One end of the first circulation channel 210 is connected to the liquid storage tank 200, while the other end of the first circulation channel 210 is connected upstream of the filter 204 of the liquid cartridge 202 in the liquid circulation direction (the region to the left-hand side of the filter 204 in FIG. 8).

One end of the second circulation channel 220 is connected to the liquid storage tank 200, while the other end of the second circulation channel 220 is connected downstream of the filter 204 of the liquid cartridge 202 in the liquid circulation direction (the region to the right-hand side of the filter 204 in FIG. 8).

A pump 222, for generating a forced flow of the liquid in the liquid circulation direction, is arranged in the second circulation channel 220.

Due to this composition, the application liquid is caused to circulate, in response to driving of the pump 222, through a second circuit constituted of the first circulation channel 210, the liquid cartridge 202 and the second circulation channel 220, so that foreign matter or the like can be trapped by the filter 204 of the liquid cartridge 202, and all the foreign matter or the like trapped by the filter 204 can be easily removed along with the liquid cartridge 202 when the liquid cartridge 202 is replaced with a new cartridge. Furthermore, causing the application liquid in the liquid storage tank 200 to circulate through the second circuit in this way also has the effect of promoting the dissolution of the application liquid products (thickened and fixed materials and so on). Consequently, channel blockage and abnormal application can be prevented, thereby improving application stability.

There are no particular restrictions on the timing for the circulation of the application liquid through the second circuit, and the circulation may be performed immediately after the application liquid filling operation has been performed, or may be performed at regular intervals during or throughout the liquid application operation, for example.

However, in the present embodiment, from the standpoint of providing a stable supply of the application liquid to the liquid holding space S, the circulation of the application liquid by the second circuit is preferably performed when the application liquid is not circulating through the first circuit including the liquid holding space S and the flow channels 120 and 130. The application liquid is made to circulate in the second circuit for a fixed duration and, after reliably removing foreign matter contained in the application liquid, circulation of the application liquid through the first circuit is started (while the circulation of the application liquid through the second circuit is halted), thus providing a stable supply of the application liquid.

In the above-described embodiments, the application of the present invention to the inkjet recording apparatus for printing is described by way of an example, but the scope of the present invention is not limited to this example. A broad range of applications are possible, including a wiring drawing apparatus for drawing electronic-circuit wiring patterns, a fine-structure formation apparatus for forming fine structures using material-deposition materials, and an apparatus which obtains various shapes and patterns using liquid functional materials, for example.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid application apparatus, comprising:
an application member which has an application surface to apply liquid to a medium;
a holding member which holds the liquid in a liquid holding space formed by abutting against the application surface of the application member, the liquid supplied to the application surface by the holding member being applied to the medium by rotating the application surface of the application member;
a storage device which stores the liquid, the storage device including a liquid cartridge having a filter to trap foreign matter contained in the liquid, the liquid cartridge being detachable with respect to the storage device;
first and second flow channels which connect the storage device and the holding member; and
a first liquid movement device which generates a flow of the liquid in a course including the first and second flow channels and the liquid holding space.

2. The liquid application apparatus as defined in claim 1, wherein the liquid cartridge is detachably arranged midway in the course including the first and second flow channels and the liquid holding space.

3. The liquid application apparatus as defined in claim 1, wherein a member contacting the liquid in each of the first and second flow channels has gas barrier properties.

4. The liquid application apparatus as defined in claim 1, wherein:
the storage device includes a liquid storage tank which stores the liquid;
the liquid storage tank is fixedly arranged midway in the course including the first and second flow channels and the liquid holding space, and has a circulation channel different from the course;
the circulation channel has a second liquid movement device which generates a flow of the liquid in the circulation channel; and
the liquid cartridge is detachably arranged midway in the circulation channel.

5. The liquid application apparatus as defined in claim 4, wherein a member contacting the liquid in each of the first and second channels and the circulation channel has gas barrier properties.

6. An image forming apparatus, comprising:
a liquid application apparatus which includes: an application member which has an application surface to apply a first liquid to a recording medium; a holding member which holds the first liquid in a liquid holding space formed by abutting against the application surface of the application member, the first liquid supplied to the application surface by the holding member being applied to the recording medium by rotating the application surface of the application member; a storage device which stores the first liquid, the storage device including a liquid cartridge having a filter to trap foreign matter contained in the first liquid, the liquid cartridge being detachable with respect to the storage device; first and second flow channels which connect the storage device and the holding member; and a first liquid movement device which generates a flow of the first liquid in a course including the first and second flow channels and the liquid holding space; and
a recording device which ejects and deposits a second liquid from a recording head to record an image onto the recording medium having been applied with the first liquid by the liquid application apparatus.

7. The image forming apparatus as defined in claim 6, wherein the liquid cartridge is detachably arranged midway in the course including the first and second flow channels and the liquid holding space.

8. The image forming apparatus as defined in claim 6, wherein a member contacting the first liquid in each of the first and second flow channels has gas barrier properties.

9. The image forming apparatus as defined in claim 6, wherein the second liquid is an ink containing a coloring material, and the first liquid is a treatment liquid which has an effect of aggregating the coloring material.

10. The image forming apparatus as defined in claim 6, wherein:
the storage device includes a liquid storage tank which stores the first liquid;
the liquid storage tank is fixedly arranged midway in the course including the first and second flow channels and the liquid holding space, and has a circulation channel different from the course;
the circulation channel has a second liquid movement device which generates a flow of the first liquid in the circulation channel; and
the liquid cartridge is detachably arranged midway in the circulation channel.

11. The image forming apparatus as defined in claim 10, wherein a member contacting the first liquid in each of the first and second channels and the circulation channel has gas barrier properties.

12. The image forming apparatus as defined in claim 10, wherein the second liquid is an ink containing a coloring material, and the first liquid is a treatment liquid which has an effect of aggregating the coloring material.

13. A liquid application method using a liquid application apparatus which comprises: an application member which has an application surface to apply liquid to a medium; a holding member which holds the liquid in a liquid holding space formed by abutting against the application surface of the application member, the liquid supplied to the application surface by the holding member being applied to the medium by rotating the application surface of the application member; a storage device which stores the liquid, the storage device including a liquid cartridge having a filter to trap foreign matter contained in the liquid, the liquid cartridge being detachable with respect to the storage device; first and second flow channels which connect the storage device and the holding member; and a first liquid movement device which generates a flow of the liquid in a course including the first and second flow channels and the liquid holding space, the method comprising the step of:
trapping foreign matter in the liquid using the filter of the liquid cartridge.

14. The liquid application method as defined in claim 13, further comprising the step of replacing the liquid cartridge including the filter having trapped the foreign matter with a new liquid cartridge.

15. The liquid application method as defined in claim 13, wherein:
the liquid cartridge is detachably arranged midway in the course including the first and second flow channels and the liquid holding space; and
the method further comprises the step of replacing the liquid cartridge including the filter having trapped the foreign matter with a new liquid cartridge.

16. The liquid application method as defined in claim 13, wherein:
the storage device includes a liquid storage tank which stores the liquid;
the liquid storage tank is fixedly arranged midway in the course including the first and second flow channels and the liquid holding space, and has a circulation channel different from the course;
the circulation channel has a second liquid movement device which generates a flow of the liquid in the circulation channel;
the liquid cartridge is detachably arranged midway in the circulation channel; and
the method further comprises the step of replacing the liquid cartridge including the filter having trapped the foreign matter with a new liquid cartridge.
